(19) United States
(12) Patent Application Publication
(10) Pub. No.: US 2026/0129696 A1
(43) Pub. Date: May 7, 2026

(54) SIDELINK ASSISTED SYSTEM INFORMATION RECEPTION

(71) Applicant: QUALCOMM Incorporated, San Diego, CA (US)

(72) Inventors: Guy SPIEGELSTEIN, Nes-Ziona (IL); Shay LANDIS, Hod Hasharon (IL); Ran BERLINER, kfar aviv (IL); Moshe BEN-ARI, Rehovot (IL); Amit BAR-OR TILLINGER, Tel-Aviv (IL); Konstantin KUPERSHLAK, Ramat Gan (IL)

(21) Appl. No.: 18/936,813

(22) Filed: Nov. 4, 2024

(51) Int. Cl. H04W 76/14; H04W 76/19

(52) U.S. Cl. CPC H04W 76/14; H04W 76/19

(57) ABSTRACT

Methods, systems, and devices for wireless communications are described. A first UE may monitor for a system information block (SIB) message from a network entity via an access link. The first UE may transmit, via a sidelink communications link between the first UE and a second UE and based on failure to receive the SIB message via the access link, a SIB sidelink request message. The SIB sidelink request message may include a request to assist the first UE in obtaining the SIB message. The second UE may receive, via an access link and from the network entity identified by the SIB sidelink request message, the SIB message. The second UE may transmit, via the sidelink communications link, an assistance message that includes a SIB payload of the SIB message or joint decoding information associated with the SIB payload in accordance with the SIB sidelink request message.

### FIELD OF TECHNOLOGY

The following relates to wireless communications, including sidelink assisted system information reception.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). UEs may communicate via sidelink communications links.

### SUMMARY

The systems, methods, and devices of this disclosure each have several innovative aspects, no single one of which is solely responsible for the desirable attributes disclosed herein.

A method for wireless communications by a first user equipment (UE) is described. The method may include receiving, via a sidelink communications link between the first UE and a second UE, a system information block (SIB) sidelink request message, where the SIB sidelink request message includes a request to assist the second UE in obtaining a SIB message from a network entity, receiving, via an access link and from the network entity identified by the SIB sidelink request message, the SIB message, and transmitting, via the sidelink communications link, an assistance message that includes a SIB payload of the SIB message or joint decoding information associated with the SIB payload in accordance with the SIB sidelink request message.

A first UE for wireless communications is described. The first UE may include one or more memories storing processor executable code, and one or more processors coupled with the one or more memories. The one or more processors may individually or collectively be operable to execute the code to cause the first UE to receive, via a sidelink communications link between the first UE and a second UE, an SIB sidelink request message, where the SIB sidelink request message includes a request to assist the second UE in obtaining a SIB message from a network entity, receive, via an access link and from the network entity identified by the SIB sidelink request message, the SIB message, and transmit, via the sidelink communications link, an assistance message that includes a SIB payload of the SIB message or joint decoding information associated with the SIB payload in accordance with the SIB sidelink request message.

Another first UE for wireless communications is described. The first UE may include means for receiving, via a sidelink communications link between the first UE and a second UE, an SIB sidelink request message, where the SIB sidelink request message includes a request to assist the second UE in obtaining a SIB message from a network entity, means for receiving, via an access link and from the network entity identified by the SIB sidelink request message, the SIB message, and means for transmitting, via the sidelink communications link, an assistance message that includes a SIB payload of the SIB message or joint decoding information associated with the SIB payload in accordance with the SIB sidelink request message.

A non-transitory computer-readable medium storing code for wireless communications is described. The code may include instructions executable by one or more processors to receive, via a sidelink communications link between the first UE and a second UE, an SIB sidelink request message, where the SIB sidelink request message includes a request to assist the second UE in obtaining a SIB message from a network entity, receive, via an access link and from the network entity identified by the SIB sidelink request message, the SIB message, and transmit, via the sidelink communications link, an assistance message that includes a SIB payload of the SIB message or joint decoding information associated with the SIB payload in accordance with the SIB sidelink request message.

In some examples of the method, first UEs, and non-transitory computer-readable medium described herein, transmitting the assistance message may include operations, features, means, or instructions for transmitting the assistance message that includes the SIB payload based on the SIB sidelink request message.

Some examples of the method, first UEs, and non-transitory computer-readable medium described herein may further include operations, features, means, or instructions for decoding the SIB message based on the SIB sidelink request message, where the assistance message that includes the SIB payload of the SIB message may be transmitted based on successful decoding of the SIB message.

Some examples of the method, first UEs, and non-transitory computer-readable medium described herein may further include operations, features, means, or instructions for transmitting the SIB message via a sidelink interface of the first UE, where the assistance message may be transmitted based on transmission of the SIB message via the sidelink interface.

Some examples of the method, first UEs, and non-transitory computer-readable medium described herein may further include operations, features, means, or instructions for transmitting the SIB sidelink request message via an access link interface of the first UE, where the assistance message may be transmitted based on transmission of the SIB sidelink request message via the access link interface.

Some examples of the method, first UEs, and non-transitory computer-readable medium described herein may further include operations, features, means, or instructions for determining whether to transmit the SIB payload or the joint decoding information based on the SIB sidelink request message.

In some examples of the method, first UEs, and non-transitory computer-readable medium described herein, the SIB sidelink request message, the assistance message, or both include one or more unicast or groupcast messages.

In some examples of the method, first UEs, and non-transitory computer-readable medium described herein, the joint decoding information includes in-phase and quadrature (IQ) measurements, log-likelihood ratios (LLRs), or both.

In some examples of the method, first UEs, and non-transitory computer-readable medium described herein, the SIB sidelink request message indicates a Public Land Mobile Network (PLMN), a Physical Cell Identity (PCI), an Absolute Radio Frequency channel number (ARFCN), or any combination thereof that identify the requested SIB message from the network entity.

In some examples of the method, first UEs, and non-transitory computer-readable medium described herein, the sidelink communications link includes a PC5 link.

In some examples of the method, first UEs, and non-transitory computer-readable medium described herein, the access link includes a Uu link.

A method for wireless communications by a first UE is described. The method may include monitoring for an SIB message from a network entity via an access link, transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity, and receiving, via the sidelink communications link, an assistance message that includes a SIB payload of the SIB message or joint decoding information associated with the SIB payload in accordance with the SIB sidelink request message.

A first UE for wireless communications is described. The first UE may include one or more memories storing processor executable code, and one or more processors coupled with the one or more memories. The one or more processors may individually or collectively be operable to execute the code to cause the first UE to monitor for an SIB message from a network entity via an access link, transmit, via a sidelink communications link between the first UE and a second UE and based on failure to receive the SIB message via the access link, a SIB sidelink request message, where the SIB sidelink request message includes a request to assist the first UE in obtaining the SIB message from the network entity, and receive, via the sidelink communications link, an assistance message that includes a SIB payload of the SIB message or joint decoding information associated with the SIB payload in accordance with the SIB sidelink request message.

Another first UE for wireless communications is described. The first UE may include means for monitoring for an SIB message from a network entity via an access link, means for transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity, and means for receiving, via the sidelink communications link, an assistance message that includes a SIB payload of the SIB message or joint decoding information associated with the SIB payload in accordance with the SIB sidelink request message.

A non-transitory computer-readable medium storing code for wireless communications is described. The code may include instructions executable by one or more processors to monitor for an SIB message from a network entity via an access link, transmit, via a sidelink communications link between the first UE and a second UE and based on failure to receive the SIB message via the access link, a SIB sidelink request message, where the SIB sidelink request message includes a request to assist the first UE in obtaining the SIB message from the network entity, and receive, via the sidelink communications link, an assistance message that includes a SIB payload of the SIB message or joint decoding information associated with the SIB payload in accordance with the SIB sidelink request message.

Some examples of the method, first UEs, and non-transitory computer-readable medium described herein may further include operations, features, means, or instructions for transmitting the SIB sidelink request message via a sidelink interface of the first UE, where the SIB sidelink request message via the sidelink communications link may be transmitted based on transmission of the SIB sidelink request message to the sidelink interface.

Some examples of the method, first UEs, and non-transitory computer-readable medium described herein may further include operations, features, means, or instructions for transmitting the assistance message via an access link interface of the first UE.

Some examples of the method, first UEs, and non-transitory computer-readable medium described herein may further include operations, features, means, or instructions for establishing or re-establishing a connection with the network entity based on the assistance message.

In some examples of the method, first UEs, and non-transitory computer-readable medium described herein, the SIB sidelink request message, the assistance message, or both include one or more unicast or groupcast messages.

In some examples of the method, first UEs, and non-transitory computer-readable medium described herein, the joint decoding information includes IQ measurements, LLRs, or both.

In some examples of the method, first UEs, and non-transitory computer-readable medium described herein, the SIB sidelink request message indicates a PLMN, a PCI, an ARFCN, or any combination thereof that identify the requested SIB message from the network entity.

In some examples of the method, first UEs, and non-transitory computer-readable medium described herein, the sidelink communications link includes a PC5 link, the access link includes a Uu link, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that supports sidelink assisted system information reception in accordance with one or more aspects of the present disclosure.

FIG. 3 shows an example of a process flow that supports sidelink assisted system information reception in accordance with one or more aspects of the present disclosure.

FIG. 4 shows an example of a flow diagram that supports sidelink assisted system information reception in accordance with one or more aspects of the present disclosure.

FIGS. 5 and 6 show block diagrams of devices that support sidelink assisted system information reception in accordance with one or more aspects of the present disclosure.

FIG. 7 shows a block diagram of a communications manager that supports sidelink assisted system information reception in accordance with one or more aspects of the present disclosure.

FIG. 8 shows a diagram of a system including a device that supports sidelink assisted system information reception in accordance with one or more aspects of the present disclosure.

FIGS. 9 and 10 show block diagrams of devices that support sidelink assisted system information reception in accordance with one or more aspects of the present disclosure.

FIG. 11 shows a block diagram of a communications manager that supports sidelink assisted system information reception in accordance with one or more aspects of the present disclosure.

FIG. 12 shows a diagram of a system including a device that supports sidelink assisted system information reception in accordance with one or more aspects of the present disclosure.

FIGS. 13 through 16 show flowcharts illustrating methods that support sidelink assisted system information reception in accordance with one or more aspects of the present disclosure.

### DETAILED DESCRIPTION

Wireless communications devices may perform initial connection using system information. For example, a user equipment (UE) may receive one or more messages indicating information and resources for communication of control messages that may facilitate establishing connectivity with a network entity. As an example, the UE may receive a master information block (MIB) message indicating a first resource allocation. The UE may monitor for a system information block (SIB) message according to the first resource allocation and may receive the SIB message indicating additional resource allocations. However, in some cases, UEs may fail to receive the SIB message. For example, a UE may fail to receive the SIB message based on a lack of coverage of a downlink control channel carrying the SIB message. In some cases, the network entity may extend the range of a coverage area of the downlink control channel by retransmitting the SIB message. However, such retransmissions may increase overhead of the attachment to the network entity.

Techniques described herein may support improved coverage of the SIB message via sidelink assistance between UEs in a coverage area of the network entity. For example, a first UE may monitor for and fail to receive a SIB message. Based on failing to receive the SIB message, the first UE may request sidelink assistance from a second UE, where the request message may identify the network entity from which the first UE is attempting to receive the SIB message. The second UE may obtain the SIB message and may provide assistance to the first UE by transmitting the payload of the SIB message or by sharing joint decoding information associated with the SIB message with the first UE. The first UE may use the SIB message or the joint decoding information to attach to the network entity. Enabling the sharing of SIB messages, joint decoding information, or both via sidelink communications links between UEs may improve a coverage level of SIB messages of a network entity and improve probabilities of attachment procedures.

Aspects of the disclosure are initially described in the context of wireless communications systems. Aspects of the disclosure are also described in the context of process flows and flow diagrams. Aspects of the disclosure are further illustrated by and described with reference to apparatus diagrams, system diagrams, and flowcharts that relate to sidelink assisted system information reception.

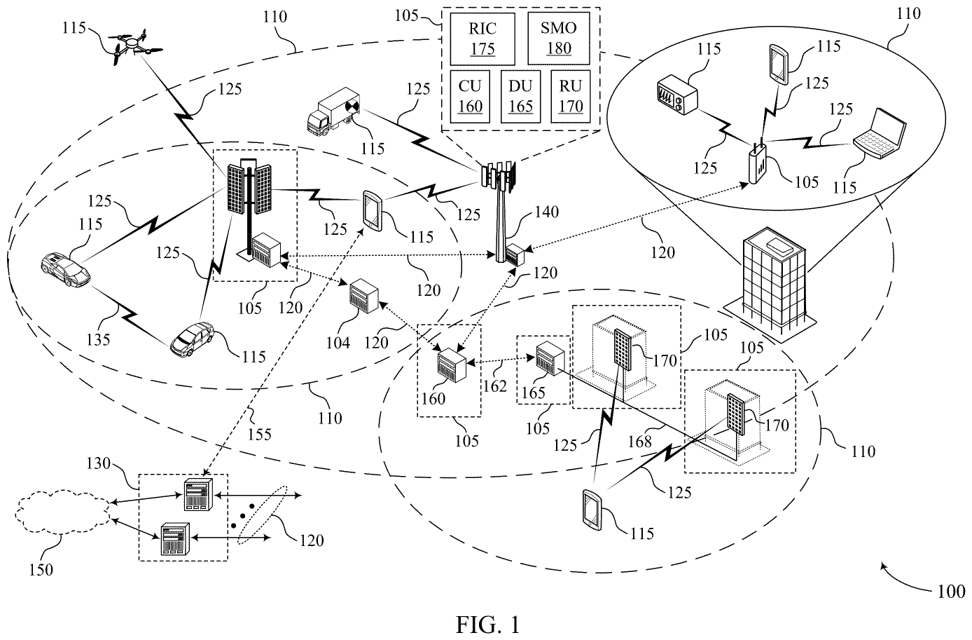

FIG. 1 shows an example of a wireless communications system 100 that supports sidelink assisted system information reception in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support sidelink assisted system information reception as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may perform initial attachment or reselection to a network entity 105. For example, the UE 115 may receive, via a physical broadcast channel (PBCH) in a synchronization signal block (SSB), a MIB. The MIB may indicate a resource allocation (e.g., a time and frequency domain resource allocation) for a first control resource set (CORESET) (e.g., CORESET0) associated with communication of a downlink control channel. The UE 115 may monitor the CORESET for downlink control message (e.g., a physical downlink control channel (PDCCH) message) carrying a SIB (e.g., SIB1). However, the UE 115 may fail to decode the downlink control message to obtain the SIB. In such examples, the wireless communications system 100 may extend a range of a coverage area for the downlink control message by enabling sidelink assistance between the UE 115 and another UE.

For example, the UE 115 (e.g., an assisted UE) may fail to receive a SIB message from the network entity 105. Based on failing to receive the SIB message, the UE 115 may transmit a sidelink assistance request message to another UE (e.g., an assisting UE). If the other UE obtains the SIB message, the other UE may provide assistance to the UE by forwarding the SIB message or by providing joint decoding information. The UE 115 may receive the assistance from the other UE and connect to the network entity 105.

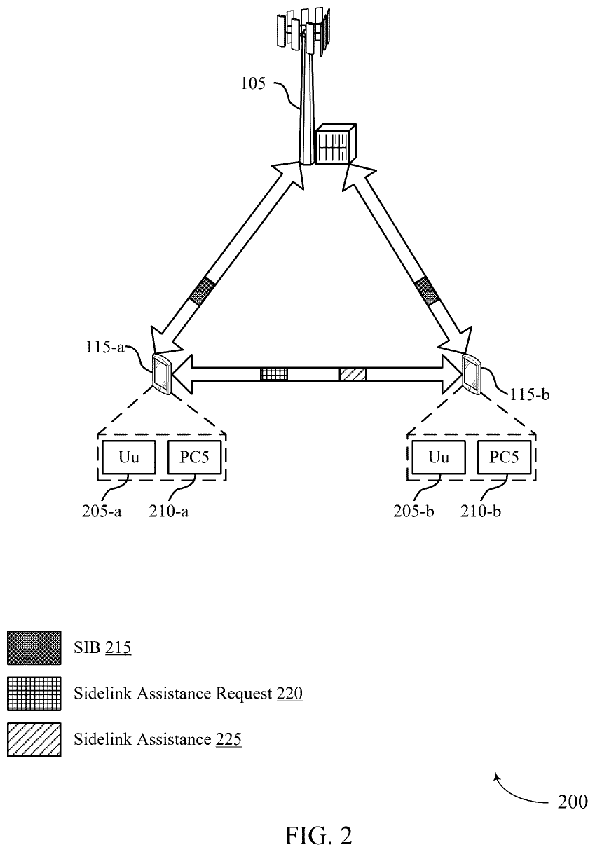

FIG. 2 shows an example of a wireless communications system 200 that supports sidelink assisted system information reception in accordance with one or more aspects of the present disclosure. The wireless communications system 200 may implement aspects of wireless communications system 100. For example, the wireless communications system 200 may include a network entity 105, a UE 115-a, and a UE 115-b, which may be examples of the corresponding devices described with reference to FIG. 1.

The UE 115-a and the UE 115-b may include respective radio frequency chains that support sidelink communications and uplink or downlink communications. For example, the UE 115-a may include a PC5 interface 210-a that supports communication with the UE 115-b (e.g., among other UEs) and a Uu interface 205-a that supports communication with the network entity 105 (e.g., among other network entities). Similarly, the UE 115-b may include a PC5 interface 210-a that supports communication with the UE 115-a and a Uu interface 205-b that supports communication with the network entity 105. As used herein, sidelink communications links may refer to PC5 links or communication via the PC5 interfaces of the UEs. Additionally, uplink and downlink communications links may refer to Uu links or communication via the Uu interfaces of the UEs.

The UE 115-b may be in a vicinity of the UE 115-a. That is, the UE 115-a and the UE 115-b may be within a threshold distance of each other. In such examples, the UE 115-a, the UE 115-b, or both may leverage radio frequency chains to acquire information from the network entity 105 and share the information via sidelink communications links. The UE 115-a and the UE 115-b may be referred to as sidelink companion devices. In some examples, usage of sidelink companion devices may enable a UE located at a cell edge to acquire system information (e.g., a SIB1) during initial attachment, re-selection, or both. For example, the UE 115-a and the UE 115-b may form an ad-hoc distributed antenna array by utilizing sidelink capabilities and improve probabilities of acquiring system information for the initial attachment and re-selection.

The UE 115-a and the UE 115-b may exchange sidelink assistance messages to obtain the assistance information. For example, the network entity 105 may transmit a SIB 215 to the UE 115-a, the UE 115-b, or both. The network entity 105 may transmit the SIB 215 in a CORESET (e.g., CORESET0), via a downlink control channel (e.g., in a PDCCH message or DCI message), or both. In some examples, the UE 115-a may fail to receive the SIB 215. For example, the UE 115-a may monitor the CORESET for the SIB 215 and fail to receive or decode the SIB 215. In such examples, the UE 115-a may transmit a sidelink assistance request 220 to the UE 115.

The sidelink assistance request 220 may indicate the network entity 105 from which the UE 115-a is attempting to receive the SIB 215 from. The UE 115-b may obtain the SIB 215 based on receiving the sidelink assistance request 220 and may transmit sidelink assistance 225 to the UE 115-a. The sidelink assistance 225 may include a payload of the SIB 215 or joint decoding information associated with the payload of the SIB 215. The UE 115-a may use the sidelink assistance 225 to connect or reconnect to the network entity 105.

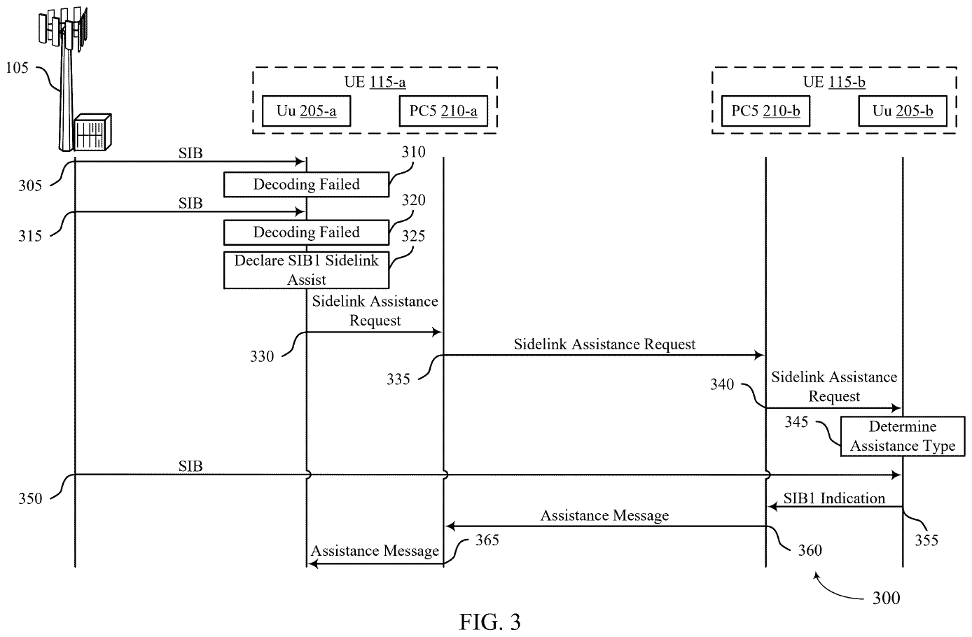

FIG. 3 shows an example of a process flow 300 that supports sidelink assisted system information reception in accordance with one or more aspects of the present disclosure. The process flow 300 may implement or be implemented by aspects of the wireless communications system 100, the wireless communications system 200, or both. For example, the process flow 300 may include a network entity 105, a UE 115-a, and a UE 115-b, which may be examples of corresponding devices as described with reference to FIGS. 1 and 2. In the example of FIG. 3, the UE 115-a may be an example of an assisted UE while the UE 115-b may be an example of an assisting UE.

Alternative examples of the following may be implemented, where some operations are performed in a different order than described or are not performed at all. In some examples, operations may include additional features not mentioned below, or further operations may be added. Although the network entity 105, the UE 115-a, and the UE 115-b are shown performing the operations of the process flow 300, some aspects of some operations may also be performed by one or more other wireless devices.

At 305, the network entity 105 may output a SIB (e.g., SIB1). For example, the network entity 105 may output SIB during a connection establishment procedure. While the network entity 105 is illustrated as transmitting the SIB to the UE 115-a, it may be understood that the SIB is a broadcast message and may be received by UEs in addition to the UE 115-a. The SIB may be an example of the SIB 215 as described with reference to FIG. 2. In some examples, the network entity 105 may broadcast the SIB in a downlink control message, such as in a PDCCH.

The UE 115-a may monitor for the SIB. For example, the UE 115-a may monitor for the SIB (e.g., a SIB message) from the network entity 105 via an access link (e.g., a Uu link). The UE 115-a may attempt to decode the SIB. At 310, the UE 115-a may determine that the decoding attempt has failed. For example, the UE 115-a may determine that decoding of a PDCCH carrying the SIB is failed. In other words, the UE 115-a may fail to decode the SIB. At 315, the network entity 105 may output another transmission of the SIB. For example, the network entity 105 may retransmit SIB to the UE 115-a based on failing to receive a response to SIB. The UE 115-a may, again, attempt to decode the SIB. At 320, the UE 115-a may determine that another decoding attempt has failed.

Based on failing to decode SIB at 310, at 320, or both, the UE 115-a may declare SIB sidelink assist. For example, the UE 115-a, after one or more unsuccessful decoding attempts, may determine to use a sidelink communications link (e.g., a PC5 link) to request assistance from other UEs in obtaining or decoding the SIB. While the UE 115-a in the example of FIG. 3 fails to decode the SIB twice, it may be understood that the UE 115-a may declare SIB sidelink assist (e.g., request assistance from a sidelink UE) after one or more failed decoding attempts of SIB. That is, the UE 115-a may declare SIB sidelink assist after a single failed decoding attempt, three failed decoding attempts, or the like.

At 330, the UE 115-a may transmit, a sidelink assistance request to the PC5 interface 210-a. For example, the UE 115-a may send the sidelink assistance request (e.g., SIB1_SL_ASSIT_REQ) to the PC5 interface 210-a (e.g., its PC5 stack) with one or more parameters that define the SIB. The parameters may include a Public Land Mobile Network (PLMN), a Physical Cell Identity (PCI), an Absolute Radio Frequency channel number (ARFCN), or any combination thereof that identify the requested SIB message from the network entity 105. The sidelink assistance request may be an example of the sidelink assistance request 220 as described with reference to FIG. 2.

At 335, the UE 115-a may transmit the sidelink assistance request. For example, the UE 115-a may transmit, via a sidelink communications link between the UE 115-a and the UE 115-b and based on failure to receive the SIB message via the access link (e.g., at 310, at 320, or both), a SIB sidelink request message. The SIB sidelink request message may include a request to assist the UE 115-a in obtaining the SIB message from the network entity 105. The SIB sidelink request message may be an example of a groupcast message or a unicast message.

In examples in which the SIB sidelink request message is a groupcast message (e.g., or broadcast message), the UE 115-a that fails to decode the SIB may initiate a broadcast or groupcast request for other sidelink devices to assist with acquiring SIB from the network entity 105. In such examples, the request may be for a SIB payload. That is, the UE 115-b that receives the SIB sidelink request message may provide the SIB payload based on the SIB sidelink request message being a broadcast or groupcast message.

Alternatively, the UE 115-a may transmit the message using a unicast connection with the UE 115-b and one or more additional UEs. For example, the UE 115-a that fails to decode the SIB may initiate a unicast request to peer sidelink devices to assist on acquiring the SIB from the network entity 105. In some examples, the unicast request may be a request for assistance using joint decoding (e.g., sharing IQ measurements or PDCCH LLR). That is, the unicast message may include an identifier that the request is for assistance via joint decoding.

The UE 115-b may receive, via a sidelink communications link between the UE 115-a and the UE 115-b, a SIB sidelink request message including a request to assist the UE 115-a in obtaining the SIB message from the network entity 105. In some examples, the UE 115-b may the sidelink assistance request at a PC5 interface 210-b (e.g., a PC5 stack or a sidelink interface). At 340, the UE 115-b may transmit the sidelink assistance request to a Uu interface 205-b. In other words, the UE 115-b may transmit the SIB sidelink request message (e.g., received via the PC5 interface 210-b) to the Uu interface 205-b (e.g., an access link interface).

At 345, the UE 115-b may determine an assistance type. For example, the UE 115-b may determine whether to transmit the SIB payload or the joint decoding information based on the SIB sidelink request message. In other words, the UE 115-b may determine if it can assist the UE 115-a by transmitting the SIB payload (e.g., if it is known) or by using joint decoding (e.g., forwarding in-phase and quadrature (IQ) measurements and/or log likelihood ratios (LLRs)).

At 350, the UE 115-b may obtain the SIB. For example, the UE 115-b may receive, via an access link and from the network entity 105 identified by the SIB sidelink request message, the SIB message. In some examples, the UE 115-b may receive the SIB prior to receiving the sidelink assistance request at 335. Alternatively, the UE 115-b may receive the SIB after receiving the sidelink request message.

The UE 115-b may attempt to decode the SIB based on receiving the sidelink assistance request from the UE 115-a. That is, the UE 115-b may decode the SIB message based on the SIB sidelink request message, where the assistance message includes the SIB payload of the SIB message based on successful decoding of the SIB message. The UE 115-b may decode the SIB message based on determining to assist the UE 115-a by transmitting the SIB payload.

Alternatively, the UE 115-b may perform joint decoding on the SIB message. That is, the UE 115-b may obtain raw data from the SIB message, where the UE 115-a may receive the raw data and perform decoding to obtain the SIB message.

For example, the UE 115-b may obtain joint decoding information (e.g., IQ measurements, LLRs, or both) rather than the SIB payload by performing joint decoding on the SIB message (e.g., rather than fully decoding the SIB message). In such examples, the UE 115-a may improve a likelihood of successfully receiving the SIB message, as the UE 115-a, the UE 115-b, or both, may fail to decode the SIB but succeed in jointly decoding the SIB.

At 355, the UE 115-b may transmit the SIB message or the joint decoding information to the PC5 interface 210-b (e.g., a sidelink interface). That is, the UE 115-b may send the requested SIB payload to the PC5 interface 210-b (e.g., PC5 stack) of the UE 115-b. Additionally, or alternatively, the UE 115-b may notify the PC5 interface 210-b that the UE 115-b is to support the request for assistance from the UE 115-a.

At 360, the UE 115-b may transmit the assistance message. For example, the UE 115-b may transmit, via the sidelink communications link, an assistance message that includes a SIB payload of the SIB message or joint decoding information associated with the SIB payload in accordance with the SIB sidelink request message. The assistance message may be an example of the sidelink assistance 225 as described with reference to FIG. 2.

In some examples, the UE 115-b may broadcast the assistance message. For example, the UE 115-b may broadcast the assistance message (e.g., broadcast or groupcast message) with the SIB payload. In examples in which the UE 115-b obtained the SIB before receiving the sidelink assistance request, the UE 115-b may transmit the SIB payload previously obtained. Alternatively, the UE 115-b may transmit the SIB payload after successfully receiving or decoding the SIB. Alternatively, the UE 115-b may transmit the assistance message via a unicast connection. For example, the UE 115-b may include the requested information in a sidelink message and via a unicast connection to the PC5 interface 210-a of the UE 115-a. That is, the UE 115-b may transmit the SIB payload or joint decoding information (e.g., IQ, LLR, or both).

The UE 115-a may receive the assistance message at the PC5 interface 210-a. At 365, the UE 115-a may transmit the sidelink assistance to the Uu interface 205-a. For example, the UE 115-a may receive the sidelink assistance message and deliver the assistance message to the Uu interface 205-a (e.g., the Uu stack).

After receiving the assistance message, the UE 115-a may attempt to establish or re-establish a connection with the network entity 105. In examples in which the UE 115-a receives the SIB payload, the UE 115-a may use the SIB for initial attachment or re-selection. Alternatively, in examples in which the UE 115-a receives joint decoding information, the UE 115-a may attempt joint decoding. The UE 115-a may continue with initial attachment or re-selection procedures based on successfully performing the joint decoding.

By receiving the sidelink assistance from the UE 115-b, the UE 115-a may leverage information of other sidelink devices in a vicinity of the UE 115-a to exchange a SIB payload (e.g., with a payload size of up to 2976 bits). In the example of receiving joint decoding information, the UE 115-a may perform joint decoding using raw data conveyed over a unicast, sidelink communications link (e.g., a PC5 unicast link) from peer devices in a vicinity of the UE 115-a. In such examples, the UE 115-a may rely on decoding information from radio frequency chains of one or more assisting UEs in addition to the radio frequency chains at the UE 115-a (e.g., rather than decoding information only from the radio frequency chains of the UE 115-a). In some examples, the UE 115-a may improve physical downlink shared channel (PDSCH) decoding by performing joint decoding via the assisting UE. In examples in which the UE 115-a receives the SIB payload itself and the joint decoding information, the UE 115-a may create an ad hoc assisted receiver formation or a distributed receiver where the UE 115-a may receive assistance via an assisting UE, such as via the UE 115-b.

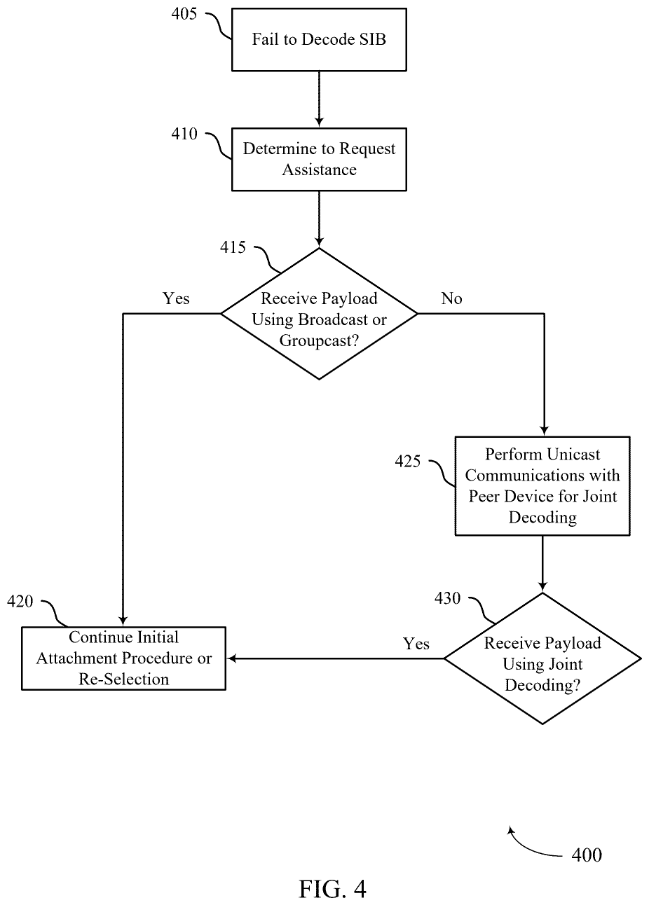

FIG. 4 shows an example of a flow diagram 400 that supports sidelink assisted system information reception in accordance with one or more aspects of the present disclosure. The flow diagram 400 may implement or be implemented by aspects of the wireless communications system 100, the wireless communications system 200, the process flow 300, or any combination thereof. For example, the flow diagram 400 may be implemented by a UE, which may be an example of the UE 115-a (e.g., an assisted UE) as described with reference to FIGS. 2 and 3. In the example of FIG. 3, the UE 115-a may be an example of an assisted UE while the UE 115-b may be an example of an assisting UE.

Alternative examples of the following may be implemented, where some operations are performed in a different order than described or are not performed at all. In some examples, operations may include additional features not mentioned below, or further operations may be added. Although the UE is described as performing the operations of the flow diagram 400, some aspects of some operations may also be performed by one or more other wireless devices.

At 405, a UE may fail to decode a SIB. For example, the UE may monitor for and fail to decode a SIB message transmitted by a network entity, where the UE is attempting to establish a connection with the network entity. At 410, the UE may determine to request assistance. The UE may determine to request assistance based on failing to decode the SIB at 405. In some examples, the UE 115 may fail to decode the SIB multiple times before determining to request assistance.

The UE may request assistance initially using broadcast or groupcast. That is, the UE may transmit a broadcast or groupcast message requesting assistance from one or more UEs in a range of the broadcast or groupcast message (e.g., in a vicinity of the UE). The UE may initially request assistance using the broadcast or groupcast message to reduce latency and avoid establishing a dedicated unicast session. The broadcast or groupcast message may request that an assisting UE provide the UE with a SIB payload of the SIB from the network entity. For example, the broadcast or groupcast message may implicitly indicate that the UE is requesting assistance in obtaining the SIB payload based on the request being in a broadcast or groupcast message.

At 415, the UE may determine whether the payload was received using broadcast or groupcast. For example, the UE may determine whether an assistance message including a SIB payload was received via groupcast or broadcast from an assisting UE in response to the broadcast or groupcast message. If the assistance message was received, the UE may continue an initial attachment procedure or re-selection (e.g., establish or re-establish a connection with the network entity) at 420. Alternatively, if the assistance message was not received, the UE may perform unicast communications with a peer device for joint decoding at 425. That is, in an example in which the UE was unable to obtain the SIB payload, the UE may move to initiate a unicast session with a peer UE and leverage joint decoding to be able to receive the SIB message to successfully achieve initial attachment or re-selection.

For example, the UE may transmit a unicast message requesting assistance in obtaining the SIB message using joint decoding. The UE may transmit an assistance request directly to a peer UE via a unicast communications link. The peer UE may respond to the UE with joint decoding information based on performing joint decoding on the SIB message. For example, the peer UE may provide IQ measurements, LLRs, or both for the SIB message. The UE may obtain the SIB payload based on the provided joint decoding information. That is, the UE may perform joint decoding using the joint decoding information provided by the peer UE to identify the SIB payload.

At 430, the UE may determine whether the payload was received using joint decoding. If the SIB payload was successfully received, the UE may continue the initial attachment procedure or re-selection (e.g., establish or re-establish a connection with the network entity) at 420. Alternatively, the UE may continue requesting broadcast or groupcast assistance, unicast assistance, or both.

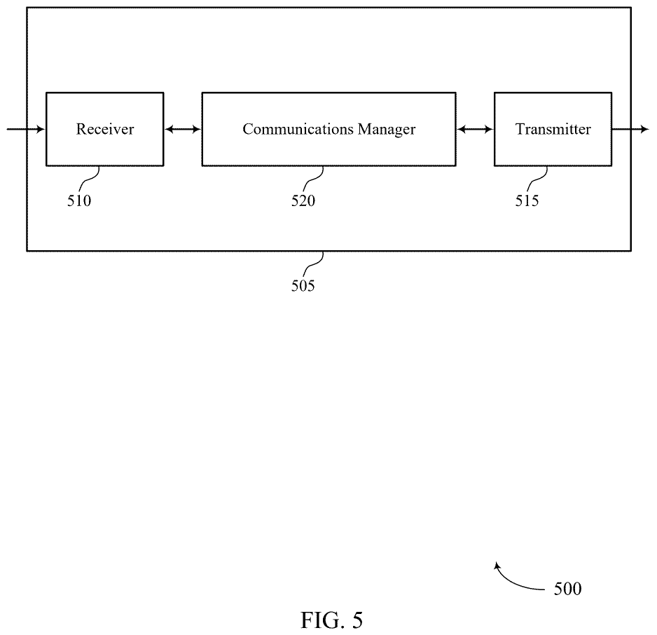

FIG. 5 shows a block diagram 500 of a device 505 that supports sidelink assisted system information reception in accordance with one or more aspects of the present disclosure. The device 505 may be an example of aspects of an assisting UE as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques.

Each of these components may be in communication with one another (e.g., via one or more buses).

The receiver 510 may provide a means for receiving information such as packets, user data, control information, or any combination thereof associated with various information channels (e.g., control channels, data channels, information channels related to sidelink assisted system information reception). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sidelink assisted system information reception). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of sidelink assisted system information reception as described herein.

For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a sidelink communications link between the first UE and a second UE, an SIB sidelink request message, where the SIB sidelink request message includes a request to assist the second UE in obtaining a SIB message from a network entity. The communications manager 520 is capable of, configured to, or operable to support a means for receiving, via an access link and from the network entity identified by the SIB sidelink request message, the SIB message. The communications manager 520 is capable of, configured to, or operable to support a means for transmitting, via the sidelink communications link, an assistance message that includes a SIB payload of the SIB message or joint decoding information associated with the SIB payload in accordance with the SIB sidelink request message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

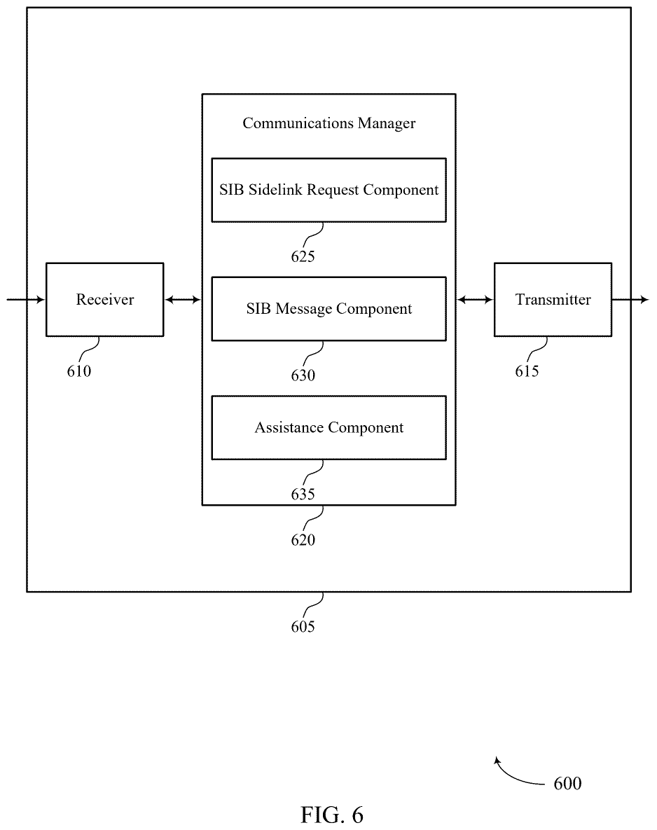

FIG. 6 shows a block diagram 600 of a device 605 that supports sidelink assisted system information reception in accordance with one or more aspects of the present disclosure. The device 605 may be an example of aspects of a device 505 or an assisting UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to sidelink assisted system information reception). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sidelink assisted system information reception). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of sidelink assisted system information reception as described herein. For example, the communications manager 620 may include an SIB sidelink request component 625, an SIB message component 630, an assistance component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SIB sidelink request component 625 is capable of, configured to, or operable to support a means for receiving, via a sidelink communications link between the first UE and a second UE, an SIB sidelink request message, where the SIB sidelink request message includes a request to assist the second UE in obtaining a SIB message from a network entity. The SIB message component 630 is capable of, configured to, or operable to support a means for receiving, via an access link and from the network entity identified by the SIB sidelink request message, the SIB message. The assistance component 635 is capable of, configured to, or operable to support a means for transmitting, via the sidelink communications link, an assistance message that includes a SIB payload of the SIB message or joint decoding information associated with the SIB payload in accordance with the SIB sidelink request message.

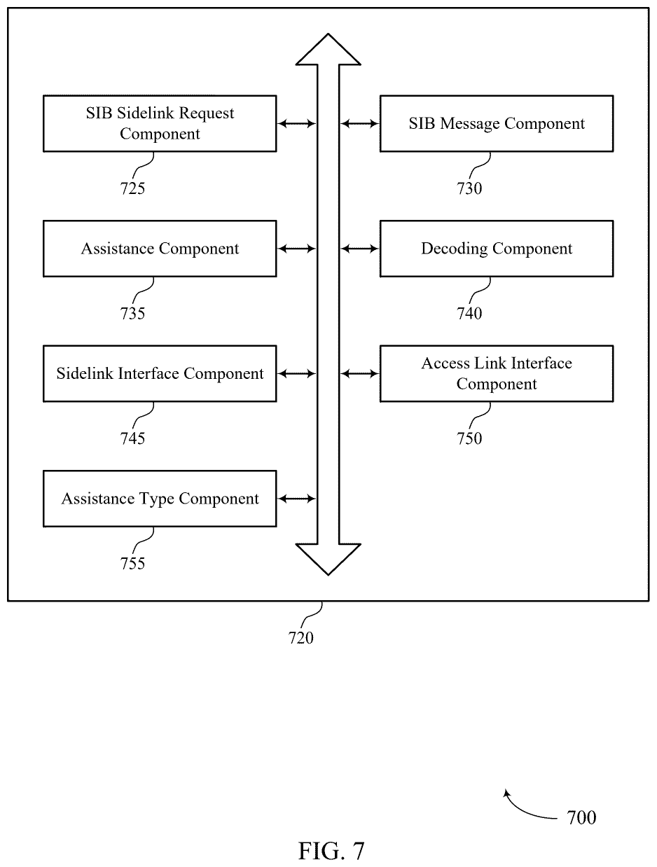

FIG. 7 shows a block diagram 700 of a communications manager 720 that supports sidelink assisted system information reception in accordance with one or more aspects of the present disclosure. The communications manager 720 may be an example of aspects of a communications manager 520, a communications manager 620, or both, as described herein. The communications manager 720, or various components thereof, may be an example of means for performing various aspects of sidelink assisted system information reception as described herein. For example, the communications manager 720 may include an SIB sidelink request component 725, an SIB message component 730, an assistance component 735, a decoding component 740, a sidelink interface component 745, an access link interface component 750, an assistance type component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SIB sidelink request component 725 is capable of, configured to, or operable to support a means for receiving, via a sidelink communications link between the first UE and a second UE, an SIB sidelink request message, where the SIB sidelink request message includes a request to assist the second UE in obtaining a SIB message from a network entity. The SIB message component 730 is capable of, configured to, or operable to support a means for receiving, via an access link and from the network entity identified by the SIB sidelink request message, the SIB message. The assistance component 735 is capable of, configured to, or operable to support a means for transmitting, via the sidelink communications link, an assistance message that includes a SIB payload of the SIB message or joint decoding information associated with the SIB payload in accordance with the SIB sidelink request message.

In some examples, to support transmitting the assistance message, the assistance component 735 is capable of, configured to, or operable to support a means for transmitting the assistance message that includes the SIB payload based on the SIB sidelink request message.

In some examples, the decoding component 740 is capable of, configured to, or operable to support a means for decoding the SIB message based on the SIB sidelink request message, where the assistance message that includes the SIB payload of the SIB message is transmitted based on successful decoding of the SIB message.

In some examples, the sidelink interface component 745 is capable of, configured to, or operable to support a means for transmitting the SIB message via a sidelink interface of the first UE, where the assistance message is transmitted based on transmission of the SIB message via the sidelink interface.

In some examples, the access link interface component 750 is capable of, configured to, or operable to support a means for transmitting the SIB sidelink request message via an access link interface of the first UE, where the assistance message is transmitted based on transmission of the SIB sidelink request message via the access link interface.

In some examples, the assistance type component 755 is capable of, configured to, or operable to support a means for determining whether to transmit the SIB payload or the joint decoding information based on the SIB sidelink request message.

In some examples, the SIB sidelink request message, the assistance message, or both include one or more unicast or groupcast messages.

In some examples, the joint decoding information includes IQ measurements, LLRs, or both.

In some examples, the SIB sidelink request message indicates a PLMN, PCI, ARFCN, or any combination thereof that identify the requested SIB message from the network entity.

In some examples, the sidelink communications link includes a PC5 link.

In some examples, the access link includes a Uu link.

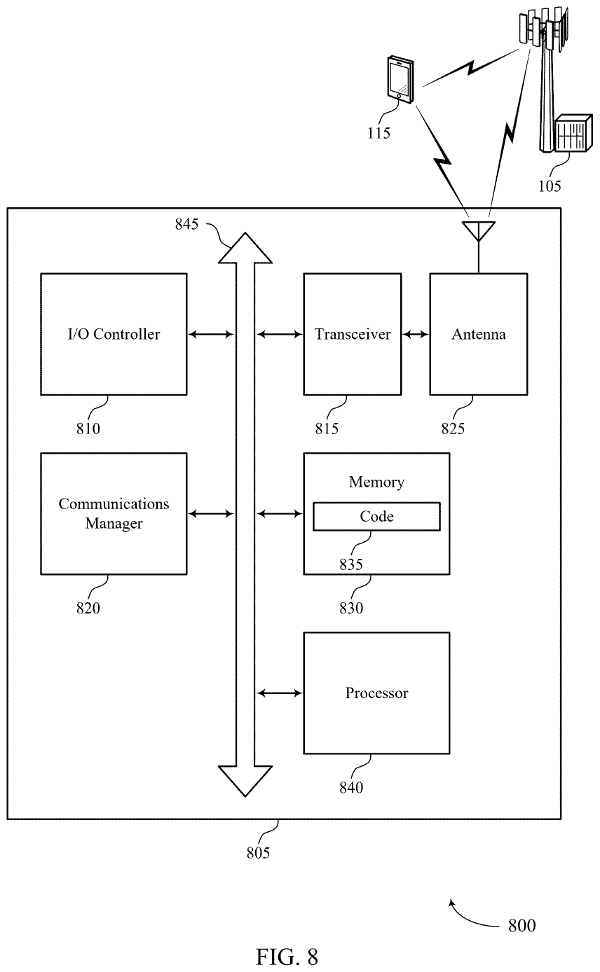

FIG. 8 shows a diagram of a system 800 including a device 805 that supports sidelink assisted system information reception in accordance with one or more aspects of the present disclosure. The device 805 may be an example of or include components of a device 505, a device 605, or an assisting UE as described herein. The device 805 may include components for bi-directional voice and data communications including components for transmitting and receiving communications, such as a communications manager 820, an I/O controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RAM and ROM. The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a BIOS which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting sidelink assisted system information reception). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, via a sidelink communications link between the first UE and a second UE, an SIB sidelink request message, where the SIB sidelink request message includes a request to assist the second UE in obtaining a SIB message from a network entity. The communications manager 820 is capable of, configured to, or operable to support a means for receiving, via an access link and from the network entity identified by the SIB sidelink request message, the SIB message. The communications manager 820 is capable of, configured to, or operable to support a means for transmitting, via the sidelink communications link, an assistance message that includes a SIB payload of the SIB message or joint decoding information associated with the SIB payload in accordance with the SIB sidelink request message.

By including or configuring the communications manager 820 in accordance with examples as described herein, the device 805 may support techniques for improved communication reliability, improved user experience related to reduced processing, reduced power consumption, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of sidelink assisted system information reception as described herein, or the at least one processor 840 and the at least one memory 830 may be otherwise configured to, individually or collectively, perform or support such operations.

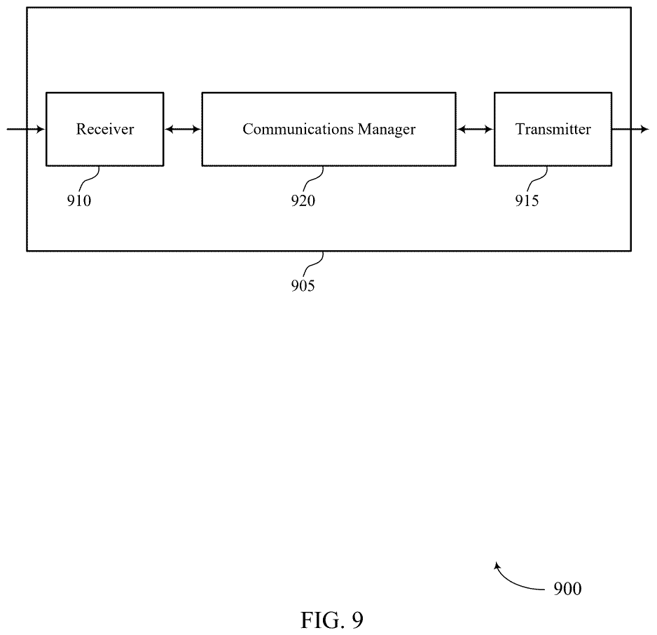

FIG. 9 shows a block diagram 900 of a device 905 that supports sidelink assisted system information reception in accordance with one or more aspects of the present disclosure. The device 905 may be an example of aspects of an assisted UE as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink assisted system information reception). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink assisted system information reception). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of sidelink assisted system information reception as described herein.

For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for monitoring for an SIB message from a network entity via an access link. The communications manager 920 is capable of, configured to, or operable to support a means for transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity. The communications manager 920 is capable of, configured to, or operable to support a means for receiving, via the sidelink communications link, an assistance message that includes a SIB payload of the SIB message or joint decoding information associated with the SIB payload in accordance with the SIB sidelink request message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

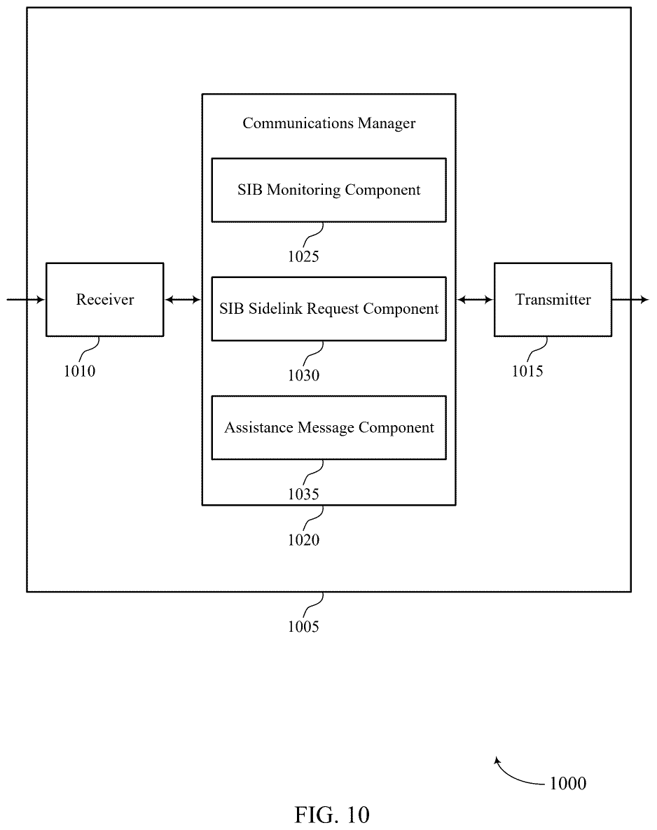

FIG. 10 shows a block diagram 1000 of a device 1005 that supports sidelink assisted system information reception in accordance with one or more aspects of the present disclosure. The device 1005 may be an example of aspects of a device 905 or an assisted UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to sidelink assisted system information reception). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to sidelink assisted system information reception). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of sidelink assisted system information reception as described herein. For example, the communications manager 1020 may include an SIB monitoring component 1025, an SIB sidelink request component 1030, an assistance message component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SIB monitoring component 1025 is capable of, configured to, or operable to support a means for monitoring for an SIB message from a network entity via an access link. The SIB sidelink request component 1030 is capable of, configured to, or operable to support a means for transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity. The assistance message component 1035 is capable of, configured to, or operable to support a means for receiving, via the sidelink communications link, an assistance message that includes a SIB payload of the SIB message or joint decoding information associated with the SIB payload in accordance with the SIB sidelink request message.

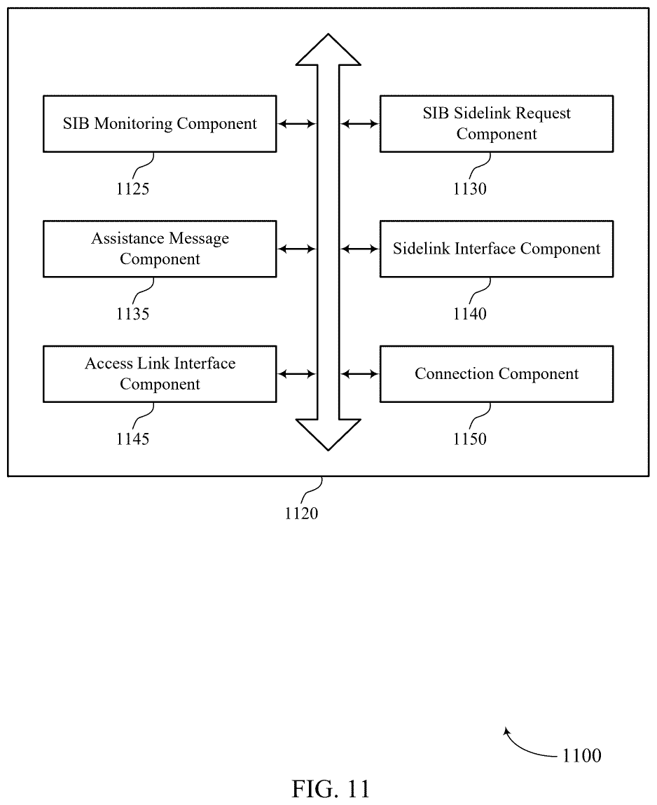

FIG. 11 shows a block diagram 1100 of a communications manager 1120 that supports sidelink assisted system information reception in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of sidelink assisted system information reception as described herein. For example, the communications manager 1120 may include an SIB monitoring component 1125, an SIB sidelink request component 1130, an assistance message component 1135, a sidelink interface component 1140, an access link interface component 1145, a connection component 1150, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The SIB monitoring component 1125 is capable of, configured to, or operable to support a means for monitoring for an SIB message from a network entity via an access link. The SIB sidelink request component 1130 is capable of, configured to, or operable to support a means for transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity. The assistance message component 1135 is capable of, configured to, or operable to support a means for receiving, via the sidelink communications link, an assistance message that includes a SIB payload of the SIB message or joint decoding information associated with the SIB payload in accordance with the SIB sidelink request message.

In some examples, the sidelink interface component 1140 is capable of, configured to, or operable to support a means for transmitting the SIB sidelink request message via a sidelink interface of the first UE, where the SIB sidelink request message via the sidelink communications link is transmitted based on transmission of the SIB sidelink request message to the sidelink interface.

In some examples, the access link interface component 1145 is capable of, configured to, or operable to support a means for transmitting the assistance message via an access link interface of the first UE.

In some examples, the connection component 1150 is capable of, configured to, or operable to support a means for establishing or re-establishing a connection with the network entity based on the assistance message.

In some examples, the SIB sidelink request message, the assistance message, or both include one or more unicast or groupcast messages.

In some examples, the joint decoding information includes IQ measurements, LLRs, or both.

In some examples, the SIB sidelink request message indicates a PLMN, PCI, ARFCN, or any combination thereof that identify the requested SIB message from the network entity.

In some examples, the sidelink communications link includes a PC5 link, the access link includes a Uu link, or both.

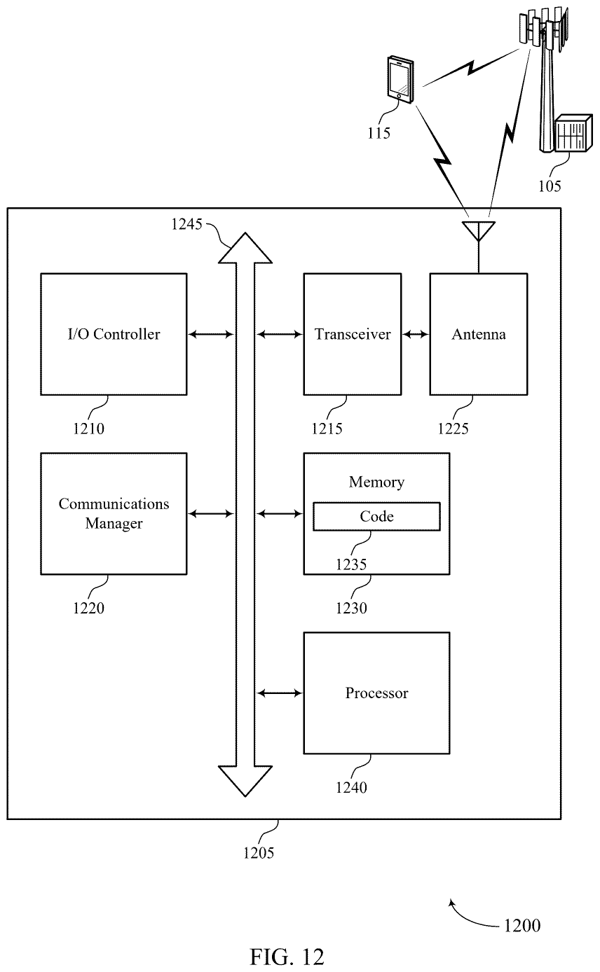

FIG. 12 shows a diagram of a system 1200 including a device 1205 that supports sidelink assisted system information reception in accordance with one or more aspects of the present disclosure. The device 1205 may be an example of or include components of a device 905, a device 1005, or an assisted UE as described herein. The device 1205 may include components for bi-directional voice and data communications including components for transmitting and receiving communications, such as a communications manager 1220, an I/O controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting sidelink assisted system information reception). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for monitoring for an SIB message from a network entity via an access link. The communications manager 1220 is capable of, configured to, or operable to support a means for transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity. The communications manager 1220 is capable of, configured to, or operable to support a means for receiving, via the sidelink communications link, an assistance message that includes a SIB payload of the SIB message or joint decoding information associated with the SIB payload in accordance with the SIB sidelink request message.

By including or configuring the communications manager 1220 in accordance with examples as described herein, the device 1205 may support techniques for improved communication reliability, improved user experience related to reduced processing, reduced power consumption, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of sidelink assisted system information reception as described herein, or the at least one processor 1240 and the at least one memory 1230 may be otherwise configured to, individually or collectively, perform or support such operations.

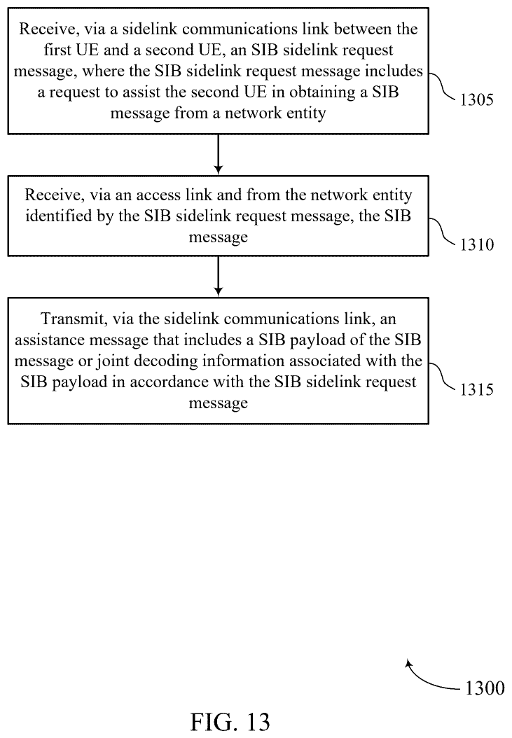

FIG. 13 shows a flowchart illustrating a method 1300 that supports sidelink assisted system information reception in accordance with one or more aspects of the present disclosure. The operations of the method 1300 may be implemented by an assisting UE or its components as described herein. For example, the operations of the method 1300 may be performed by an assisting UE as described with reference to FIGS. 1 through 8. In some examples, an assisting UE may execute a set of instructions to control the functional elements of the assisting UE to perform the described functions. Additionally, or alternatively, the assisting UE may perform aspects of the described functions using special-purpose hardware.

At 1305, the method may include receiving, via a sidelink communications link between the first UE and a second UE, an SIB sidelink request message, where the SIB sidelink request message includes a request to assist the second UE in obtaining a SIB message from a network entity. The operations of 1305 may be performed in accordance with examples as disclosed herein. In some examples, aspects of the operations of 1305 may be performed by an SIB sidelink request component 725 as described with reference to FIG. 7.

At 1310, the method may include receiving, via an access link and from the network entity identified by the SIB sidelink request message, the SIB message. The operations of 1310 may be performed in accordance with examples as disclosed herein. In some examples, aspects of the operations of 1310 may be performed by an SIB message component 730 as described with reference to FIG. 7.

At 1315, the method may include transmitting, via the sidelink communications link, an assistance message that includes a SIB payload of the SIB message or joint decoding information associated with the SIB payload in accordance with the SIB sidelink request message. The operations of 1315 may be performed in accordance with examples as disclosed herein. In some examples, aspects of the operations of 1315 may be performed by an assistance component 735 as described with reference to FIG. 7.

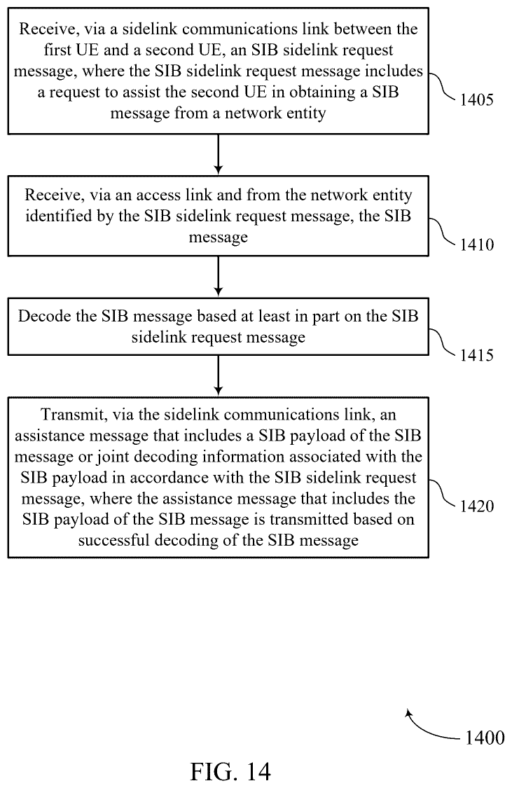

FIG. 14 shows a flowchart illustrating a method 1400 that supports sidelink assisted system information reception in accordance with one or more aspects of the present disclosure. The operations of the method 1400 may be implemented by an assisting UE or its components as described herein. For example, the operations of the method 1400 may be performed by an assisting UE as described with reference to FIGS. 1 through 8. In some examples, an assisting UE may execute a set of instructions to control the functional elements of the assisting UE to perform the described functions. Additionally, or alternatively, the assisting UE may perform aspects of the described functions using special-purpose hardware.

At 1405, the method may include receiving, via a sidelink communications link between the first UE and a second UE, an SIB sidelink request message, where the SIB sidelink request message includes a request to assist the second UE in obtaining a SIB message from a network entity. The operations of 1405 may be performed in accordance with examples as disclosed herein. In some examples, aspects of the operations of 1405 may be performed by an SIB sidelink request component 725 as described with reference to FIG. 7.

At 1410, the method may include receiving, via an access link and from the network entity identified by the SIB sidelink request message, the SIB message. The operations of 1410 may be performed in accordance with examples as disclosed herein. In some examples, aspects of the operations of 1410 may be performed by an SIB message component 730 as described with reference to FIG. 7.

At 1415, the method may include decoding the SIB message based at least in part on the SIB sidelink request message. The operations of 1415 may be performed in accordance with examples as disclosed herein. In some examples, aspects of the operations of 1415 may be performed by a decoding component 740 as described with reference to FIG. 7.

At 1420, the method may include transmitting, via the sidelink communications link, an assistance message that includes a SIB payload of the SIB message or joint decoding information associated with the SIB payload in accordance with the SIB sidelink request message, where the assistance message that includes the SIB payload of the SIB message is transmitted based at least in part on successful decoding of the SIB message. The operations of 1420 may be performed in accordance with examples as disclosed herein. In some examples, aspects of the operations of 1420 may be performed by an assistance component 735 as described with reference to FIG. 7.

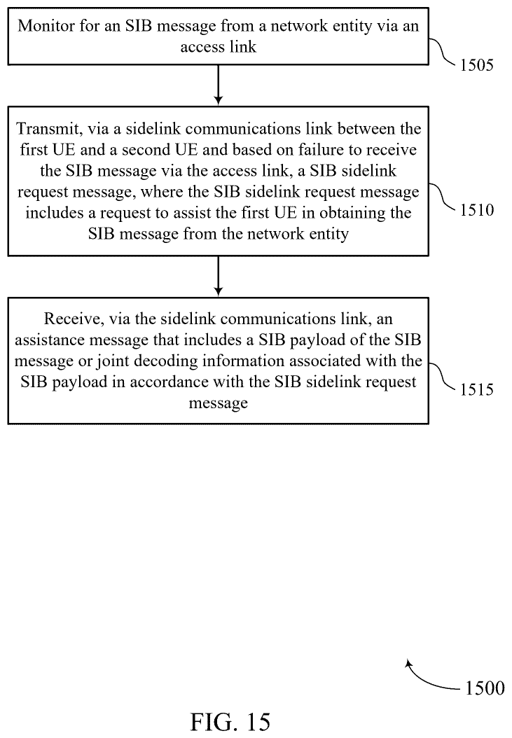

FIG. 15 shows a flowchart illustrating a method 1500 that supports sidelink assisted system information reception in accordance with one or more aspects of the present disclosure. The operations of the method 1500 may be implemented by an assisted UE or its components as described herein. For example, the operations of the method 1500 may be performed by an assisted UE as described with reference to FIGS. 1 through 4 and 9 through 12. In some examples, an assisted UE may execute a set of instructions to control the functional elements of the assisted UE to perform the described functions. Additionally, or alternatively, the assisted UE may perform aspects of the described functions using special-purpose hardware.

At 1505, the method may include monitoring for an SIB message from a network entity via an access link. The operations of 1505 may be performed in accordance with examples as disclosed herein. In some examples, aspects of the operations of 1505 may be performed by an SIB monitoring component 1125 as described with reference to FIG. 11.

At 1510, the method may include transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity. The operations of 1510 may be performed in accordance with examples as disclosed herein. In some examples, aspects of the operations of 1510 may be performed by an SIB sidelink request component 1130 as described with reference to FIG. 11.

At 1515, the method may include receiving, via the sidelink communications link, an assistance message that includes a SIB payload of the SIB message or joint decoding information associated with the SIB payload in accordance with the SIB sidelink request message. The operations of 1515 may be performed in accordance with examples as disclosed herein. In some examples, aspects of the operations of 1515 may be performed by an assistance message component 1135 as described with reference to FIG. 11.

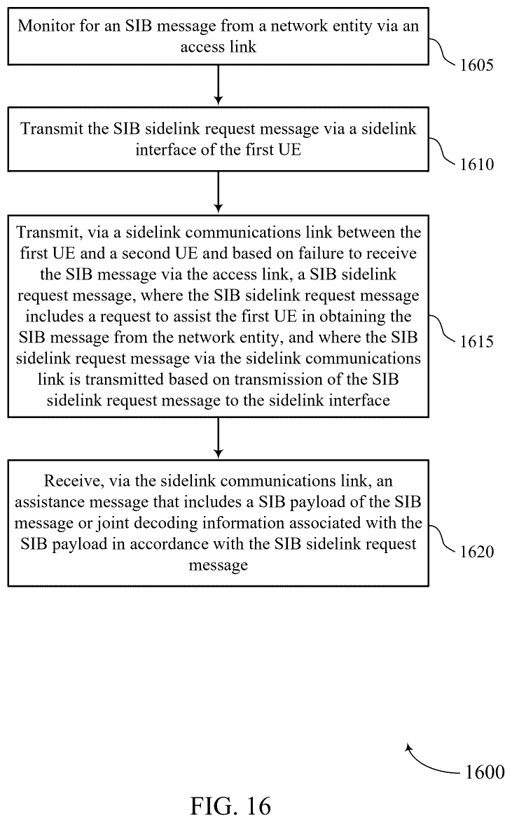

FIG. 16 shows a flowchart illustrating a method 1600 that supports sidelink assisted system information reception in accordance with one or more aspects of the present disclosure. The operations of the method 1600 may be implemented by an assisted UE or its components as described herein. For example, the operations of the method 1600 may be performed by an assisted UE as described with reference to FIGS. 1 through 4 and 9 through 12. In some examples, an assisted UE may execute a set of instructions to control the functional elements of the assisted UE to perform the described functions. Additionally, or alternatively, the assisted UE may perform aspects of the described functions using special-purpose hardware.

At 1605, the method may include monitoring for an SIB message from a network entity via an access link. The operations of 1605 may be performed in accordance with examples as disclosed herein. In some examples, aspects of the operations of 1605 may be performed by an SIB monitoring component 1125 as described with reference to FIG. 11.

At 1610, the method may include transmitting the SIB sidelink request message via a sidelink interface of the first UE, where the SIB sidelink request message via the sidelink communications link is transmitted based on transmission of the SIB sidelink request message to the sidelink interface. The operations of 1610 may be performed in accordance with examples as disclosed herein. In some examples, aspects of the operations of 1610 may be performed by a sidelink interface component 1140 as described with reference to FIG. 11.

At 1615, the method may include transmitting, via a sidelink communications link between the first UE and a second UE and based on failure to receive the SIB message via the access link, a SIB sidelink request message, where the SIB sidelink request message includes a request to assist the first UE in obtaining the SIB message from the network entity. The operations of 1615 may be performed in accordance with examples as disclosed herein. In some examples, aspects of the operations of 1615 may be performed by an SIB sidelink request component 1130 as described with reference to FIG. 11.

At 1620, the method may include receiving, via the sidelink communications link, an assistance message that includes a SIB payload of the SIB message or joint decoding information associated with the SIB payload in accordance with the SIB sidelink request message. The operations of 1620 may be performed in accordance with examples as disclosed herein. In some examples, aspects of the operations of 1620 may be performed by an assistance message component 1135 as described with reference to FIG. 11.

The following provides an overview of aspects of the present disclosure:

Aspect 1: A method for wireless communications by a first UE, comprising: receiving, via a sidelink communications link between the first UE and a second UE, an SIB sidelink request message, wherein the SIB sidelink request message includes a request to assist the second UE in obtaining a SIB message from a network entity; receiving, via an access link and from the network entity identified by the SIB sidelink request message, the SIB message; and transmitting, via the sidelink communications link, an assistance message that includes a SIB payload of the SIB message or joint decoding information associated with the SIB payload in accordance with the SIB sidelink request message.

Aspect 2: The method of aspect 1, wherein the SIB message is received prior to the SIB sidelink request message, and wherein transmitting the assistance message comprises: transmitting the assistance message that includes the SIB payload based at least in part on the SIB sidelink request message.

Aspect 3: The method of any of aspects 1 through 2, further comprising: decoding the SIB message based at least in part on the SIB sidelink request message, wherein the assistance message that includes the SIB payload of the SIB message is transmitted based at least in part on successful decoding of the SIB message.

Aspect 4: The method of any of aspects 1 through 3, further comprising: transmitting the SIB message via a sidelink interface of the first UE, wherein the assistance message is transmitted based at least in part on transmission of the SIB message via the sidelink interface.

Aspect 5: The method of any of aspects 1 through 4, further comprising: transmitting the SIB sidelink request message via an access link interface of the first UE, wherein the assistance message is transmitted based at least in part on transmission of the SIB sidelink request message via the access link interface.

Aspect 6: The method of any of aspects 1 through 5, further comprising: determining whether to transmit the SIB payload or the joint decoding information based at least in part on the SIB sidelink request message.

Aspect 7: The method of any of aspects 1 through 6, wherein the SIB sidelink request message, the assistance message, or both comprise one or more unicast or groupcast messages.

Aspect 8: The method of any of aspects 1 through 7, wherein the joint decoding information comprises IQ measurements, LLRs, or both.

Aspect 9: The method of any of aspects 1 through 8, wherein the SIB sidelink request message indicates a PLMN, a PCI, an ARFCN, or any combination thereof that identify the requested SIB message from the network entity.

Aspect 10: The method of any of aspects 1 through 9, wherein the sidelink communications link comprises a PC5 link.

Aspect 11: The method of any of aspects 1 through 10, wherein the access link comprises a Uu link.

Aspect 12: A method for wireless communications by a first UE, comprising: monitoring for an SIB message from a network entity via an access link; transmitting, via a sidelink communications link between the first UE and a second UE and based at least in part on failure to receive the SIB message via the access link, a SIB sidelink request message, wherein the SIB sidelink request message includes a request to assist the first UE in obtaining the SIB message from the network entity; and receiving, via the sidelink communications link, an assistance message that includes a SIB payload of the SIB message or joint decoding information associated with the SIB payload in accordance with the SIB sidelink request message.

Aspect 13: The method of aspect 12, further comprising: transmitting the SIB sidelink request message via a sidelink interface of the first UE, wherein the SIB sidelink request message via the sidelink communications link is transmitted based at least in part on transmission of the SIB sidelink request message to the sidelink interface.

Aspect 14: The method of any of aspects 12 through 13, further comprising: transmitting the assistance message via an access link interface of the first UE.

Aspect 15: The method of any of aspects 12 through 14, further comprising: establishing or re-establishing a connection with the network entity based at least in part on the assistance message.

Aspect 16: The method of any of aspects 12 through 15, wherein the SIB sidelink request message, the assistance message, or both comprise one or more unicast or groupcast messages.

Aspect 17: The method of any of aspects 12 through 16, wherein the joint decoding information comprises IQ measurements, LLRs, or both.

Aspect 18: The method of any of aspects 12 through 17, wherein the SIB sidelink request message indicates a PLMN, a PCI, an ARFCN, or any combination thereof that identify the requested SIB message from the network entity.

Aspect 19: The method of any of aspects 12 through 18, wherein the sidelink communications link comprises a PC5 link, the access link comprises a Uu link, or both.

Aspect 20: A first UE for wireless communications, comprising one or more memories storing processor-executable code, and one or more processors coupled with the one or more memories and individually or collectively operable to execute the code to cause the first UE to perform a method of any of aspects 1 through 11.

Aspect 21: A first UE for wireless communications, comprising at least one means for performing a method of any of aspects 1 through 11.

Aspect 22: A non-transitory computer-readable medium storing code for wireless communications, the code comprising instructions executable by one or more processors to perform a method of any of aspects 1 through 11.

Aspect 23: A first UE for wireless communications, comprising one or more memories storing processor-executable code, and one or more processors coupled with the one or more memories and individually or collectively operable to execute the code to cause the first UE to perform a method of any of aspects 12 through 19.

Aspect 24: A first UE for wireless communications, comprising at least one means for performing a method of any of aspects 12 through 19.

Aspect 25: A non-transitory computer-readable medium storing code for wireless communications, the code comprising instructions executable by one or more processors to perform a method of any of aspects 12 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive, via a sidelink communications link between the first UE and a second UE, a system information block (SIB) sidelink request message, wherein the SIB sidelink request message includes a request to assist the second UE in obtaining a SIB message from a network entity;
receive, via an access link and from the network entity identified by the SIB sidelink request message, the SIB message; and
transmit, via the sidelink communications link, an assistance message that includes a SIB payload of the SIB message or joint decoding information associated with the SIB payload in accordance with the SIB sidelink request message.

2. The first UE of claim 1, wherein, to transmit the assistance message, the one or more processors are individually or collectively operable to execute the code to cause the first UE to:
transmit the assistance message that includes the SIB payload based at least in part on the SIB sidelink request message.

3. The first UE of claim 1, wherein the one or more processors are individually or collectively further operable to execute the code to cause the first UE to:
decode the SIB message based at least in part on the SIB sidelink request message, wherein the assistance message that includes the SIB payload of the SIB message is transmitted based at least in part on successful decoding of the SIB message.

4. The first UE of claim 1, wherein the one or more processors are individually or collectively further operable to execute the code to cause the first UE to:
transmit the SIB message via a sidelink interface of the first UE, wherein the assistance message is transmitted based at least in part on transmission of the SIB message via the sidelink interface.

5. The first UE of claim 1, wherein the one or more processors are individually or collectively further operable to execute the code to cause the first UE to:
transmit the SIB sidelink request message via an access link interface of the first UE, wherein the assistance message is transmitted based at least in part on transmission of the SIB sidelink request message via the access link interface.

6. The first UE of claim 1, wherein the one or more processors are individually or collectively further operable to execute the code to cause the first UE to:
determine whether to transmit the SIB payload or the joint decoding information based at least in part on the SIB sidelink request message.

7. The first UE of claim 1, wherein the SIB sidelink request message, the assistance message, or both comprise one or more unicast or groupcast messages.

8. The first UE of claim 1, wherein the joint decoding information comprises in-phase and quadrature (IQ) measurements, log-likelihood ratios (LLRs), or both.

9. The first UE of claim 1, wherein the SIB sidelink request message indicates a Public Land Mobile Network (PLMN), a Physical Cell Identity (PCI), an Absolute Radio Frequency channel number (ARFCN), or any combination thereof that identify the requested SIB message from the network entity.

10. The first UE of claim 1, wherein the sidelink communications link comprises a PC5 link.

11. The first UE of claim 1, wherein the access link comprises a Uu link.

12. A first user equipment (UE), comprising:
one or more memories storing processor-executable code; and
one or more processors coupled with the one or more memories and individually or collectively operable to execute the code to cause the first UE to:
monitor for a system information block (SIB) message from a network entity via an access link;
transmit, via a sidelink communications link between the first UE and a second UE and based at least in part on failure to receive the SIB message via the access link, a SIB sidelink request message, wherein the SIB sidelink request message includes a request to assist the first UE in obtaining the SIB message from the network entity; and
receive, via the sidelink communications link, an assistance message that includes a SIB payload of the SIB message or joint decoding information associated with the SIB payload in accordance with the SIB sidelink request message.

13. The first UE of claim 12, wherein the one or more processors are individually or collectively further operable to execute the code to cause the first UE to:
transmit the SIB sidelink request message via a sidelink interface of the first UE, wherein the SIB sidelink request message via the sidelink communications link is transmitted based at least in part on transmission of the SIB sidelink request message to the sidelink interface.

14. The first UE of claim 12, wherein the one or more processors are individually or collectively further operable to execute the code to cause the first UE to:
transmit the assistance message via an access link interface of the first UE.

15. The first UE of claim 12, wherein the one or more processors are individually or collectively further operable to execute the code to cause the first UE to:
establish or re-establish a connection with the network entity based at least in part on the assistance message.

16. The first UE of claim 12, wherein the SIB sidelink request message, the assistance message, or both comprise one or more unicast or groupcast messages.

17. The first UE of claim 12, wherein the joint decoding information comprises in-phase and quadrature (IQ) measurements, log-likelihood ratios (LLRs), or both.

18. The first UE of claim 12, wherein the SIB sidelink request message indicates a Public Land Mobile Network (PLMN), a Physical Cell Identity (PCI), an Absolute Radio Frequency channel number (ARFCN), or any combination thereof that identify the requested SIB message from the network entity.

19. The first UE of claim 12, wherein the sidelink communications link comprises a PC5 link, the access link comprises a Uu link, or both.

20. A method for wireless communications by a first user equipment (UE), comprising:
monitoring for a system information block (SIB) message from a network entity via an access link;
transmitting, via a sidelink communications link between the first UE and a second UE and based at least in part on failure to receive the SIB message via the access link, a SIB sidelink request message, wherein the SIB sidelink request message includes a request to assist the first UE in obtaining the SIB message from the network entity; and
receiving, via the sidelink communications link, an assistance message that includes a SIB payload of the SIB message or joint decoding information associated with the SIB payload in accordance with the SIB sidelink request message.
